(19) United States
(12) Patent Application Publication
(10) Pub. No.: US 2010/0161779 A1
(43) Pub. Date: Jun. 24, 2010

(54) SYSTEM AND METHOD FOR PROVIDING QUALITY-REFERENCED MULTIMEDIA

(75) Inventors: Earl Wayne Vanderhoff, Cranston, RI (US); Alexander Laparidis, Mansfield, MA (US); Leonardo Chen, Medford, MA (US)

Correspondence Address: VERIZON;PATENT MANAGEMENT GROUP, 1320 North Court House Road, 9th Floor, ARLINGTON, VA, 22201-2909, US

(73) Assignees: VERIZON SERVICES ORGANIZATION INC, Irving, TX (US); VERIZON SERVICES CORP., Arlington, VA (US)

(21) Appl. No.: 12/343,579

(22) Filed: Dec. 24, 2008

(51) Int. Cl. G06F 15/173

(52) U.S. Cl. 709/223

(57) ABSTRACT

A system and method for providing quality-referenced multimedia including a receiver configured to receive multimedia from at least one multimedia source, and one or more processors configured to generate a quality reference based on the multimedia, format the quality reference into an elementary stream, and associate the elementary stream with the multimedia to form quality-referenced multimedia. The system and method may also include a transmitter configured to transmit the quality-referenced multimedia for output at one or more output devices and one or more storage systems for storing the quality-referenced multimedia.

### BACKGROUND INFORMATION

With recent technological advances, video-on-demand (VoD) systems have enabled viewers to enjoy various multimedia content, such as television programs and movies, with high video and audio quality. In order to determine, at a remote site, the quality of a multimedia file being delivered, a quality reference would be required. The quality reference may indicate whether the multimedia file is a near-exact copy, a good copy, a fair copy, and/or a poor copy. However, conventional systems lack a technique for providing and/or delivering quality-referenced multimedia content on-demand within existing technologies.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 depicts a block diagram of a system architecture for providing quality-referenced multimedia, according to an exemplary embodiment;

FIG. 2 depicts a flowchart of a method for providing quality-referenced multimedia, according to an exemplary embodiment; and

FIG. 3 depicts a flowchart of a method for using quality-referenced multimedia, according to an exemplary embodiment.

### DETAILED DESCRIPTION OF EMBODIMENTS

Reference will now be made in detail to exemplary embodiments, examples of which are illustrated in the accompanying drawings. Wherever possible, the same reference numbers will be used throughout the drawings to refer to the same or like parts. It should be appreciated that the following detailed description are exemplary and explanatory only and are not restrictive.

The exemplary systems and methods are discussed in terms of providing “quality” or a “quality metric/reference.” Therefore, it should be appreciated that as used herein, “quality” may refer to a measurement of (1) the perceived quality of the rendered video and/or reproduced audio without comparison, and regardless of any particular and specific timing, amplitude, or structural parameter of the signal or (2) the structural, timing, amplitude, and/or perceived differences between an original video and/or audio and that same multimedia after processing and/or transport/distribution. For example, for video content, a “quality metric/reference” may indicate characteristics of the video content, such as brightness, color, contrast, etc. In other words, a “quality metric/reference” may provide a description of multimedia content, frame-by-frame or other similar interval. This may allow determination of degradation (e.g., one or more delta values) of multimedia content.

Accordingly, it should be appreciated that “quality” references may fall into several generalized categories. A first category for “quality” references may be referred to as “unreferenced quality.” Here, as described above, a rendered video and/or audio may be qualified without comparison. Without some sense of the original video and/or audio, it is essentially impossible to determine the contributed defects from additional processing or propagation from a signal degradation perspective. Thus, unreferenced quality may be considered a highly ineffective categorization.

A second category for “quality” references may be referred to as “referenced quality.” Here, a video and/or audio may be compared to a reference video and/or audio (e.g., an original) for differences or impairments. In essence, this categorization provides side-by-side monitoring as the basis for measuring quality. While being substantially more effective in determining differences and degradation when compared to unreferenced quality, referenced quality may nevertheless experience several drawbacks.

For example, in the case of determining the effects of transport or processing, the original video and/or audio (e.g., via signal streams) may arrive at the compare site unprocessed, which is seldom possible for live transmissions. Also, the reference video and/or audio may require bandwidth equal to that of the compare signal, which may also not normally be practical or even possible. Furthermore, the reference video and/or audio may be synchronized with the compare video and/or audio to maintain identical or similar scene and audio reproduction.

It should be appreciated that a variation on referenced video may be to deliver a copy of the reference video and/or audio to the compare site and to synchronize the playback of that video and/or audio signal (e.g., digital or analog) with the compare video and/or audio that has undergone some additional processing and/or propagation. For “live” video and/or audio streams, this may be difficult to perform as the reference video and/or audio playback typically starts with the compare video and/or audio and remains synchronized throughout its duration. The video and/or audio streams may also require prior knowledge of the video and/or audio content that will be tested. Impulse systems, such as video-on-demand (VoD), do not generally provide such knowledge.

As a result, because referenced video and/or audio comparison are generally used where two end-of-line processors (e.g., television demodulators) are connected at a single source location, reference video and/or audio comparison may very seldom be available for testing of a unique transport system or signal processing.

A third category for “quality” references may be referred to as “partially referenced.” Here, parameters of a reference video and/or audio signal may be sampled and the resultant metrics transmitted as a separate metric (or telemetry) to the alternate site, where the same procedures are performed against the delivered processed video/audio and the two results compared. A coarse example of this may include comparing a full resolution video and/or audio signal against a transmitted “thumbnail” of the reference signal, where the “thumbnail” is a substantially compressed and significantly less detailed version.

It should be appreciated that any of the above quality categories may be performed by viewing the video and/or listening to the audio, or via automation. In the case of automation, mathematical operatives, such as summing or averaging parameters (e.g., luminance level, chrominance phase, etc.—against time) may be employed. Additionally, the above categorizations of “quality” may require unique distribution of the reference or partial reference signal in order to perform the testing.

A fourth category for “quality” references may be referred to as “test pattern insertion.” Here, a test pattern with specific and known parameters into the original video and/or audio stream. Generally, these signals may be static in nature and may not require synchronization at the remote end. The signals may be recovered at the remote end and analyzed to determine if there are any differences from the original specifications. In certain scenarios (e.g., analog), test signals may be in NTSC (National Television Standards Committee), PAL (Programming Assembly Language), or SECAM (Sequentiel Couleur Avec Memoire or Sequential Color With Memory) format. These test signals may be typically inserted into the vertical blanking interval (VBI), which is “blanked” and therefore not available in the resultant video or audio from standard consumer-grade monitoring equipment. However, in the case of some forms of MPEG (Moving Pictures Experts Group) formats, a test signal may be placed the into unused bits of a digital stream.

Sound quality and audio/video synchronization may be qualified in a similar manner. Audio synchronization may be achieved when there is no perceivable delay between video activity and the corresponding audio indicated by the scene. For instance, when viewing a hammer striking a nail, one would expect to hear a noise at the moment the hammer is seen striking the nail.

Thus, exemplary embodiments may provide a system and method for providing quality-referenced multimedia. That is, exemplary embodiments may, among other things, expand the marketplace, particularly the on-demand marketplace, by providing and/or encoding multimedia quality references in video, audio, and/or other digital content and distributing such content in a manner that is efficient for operation within the framework of existing on-demand technologies.

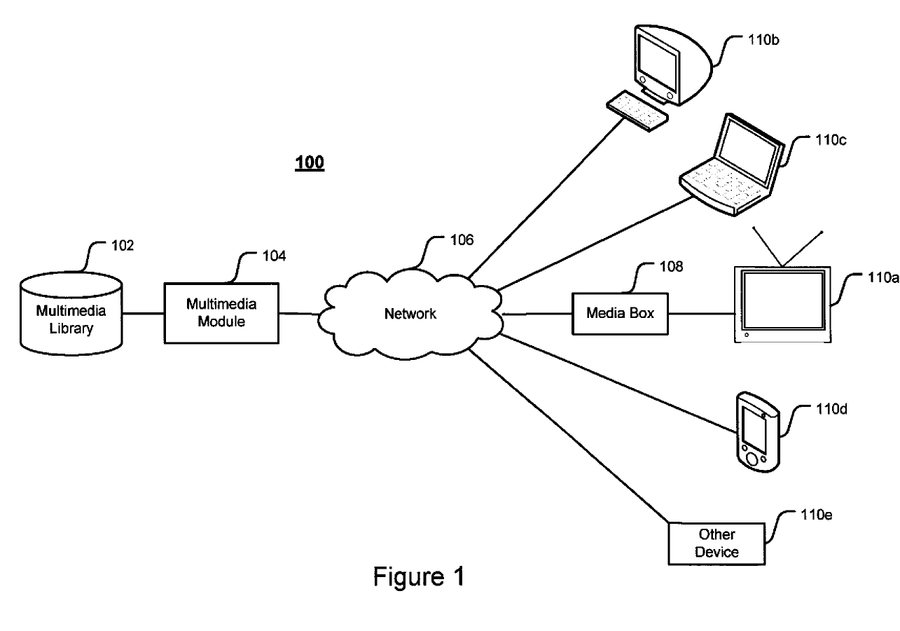

FIG. 1 depicts a block diagram of a system architecture for providing quality-reference multimedia, according to an exemplary embodiment. The system 100 may be referred to as having a vendor side and a subscriber side. The vendor side of the system 100 may include a multimedia library 102 and a multi media module 104 (e.g., a video-on-demand (VoD) server). The vendor side may connect to the subscriber side via network 106. The subscriber side may include, among other things, a media box 108 and an output device 110, such as a display device 110a, a computer 110b, a laptop/notebook 110c, a handheld multimedia device 110d, and/or other device 110e capable of communicating with vendor side components.

The network 106 may include any network (e.g., Internet) for communicatively coupling servers, modules, devices, and/or network systems. The network 106 may provide communication ability between the various servers, modules, devices, and/or network systems via electric, electromagnetic, and/or optical signals that carry digital data streams. For example, the network 106 may be a wireless network, a wired network or any combination of wireless network and wired network. For example, the network 106 may include, without limitation, Internet network, satellite network (e.g., operating in Band C, Band Ku and/or Band Ka), wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other wireless network for transmitting a signal. In addition, the network 106 may include, without limitation, telephone line, fiber optics, IEEE Ethernet 802.3, wide area network (WAN), local area network (LAN), global network such as the Internet. Also, the internal data network 106 may enable, an Internet network, a wireless communication network, a cellular network, an Intranet, or the like, or any combination thereof. The network 106 may further include one, or any number of the exemplary types of networks mentioned above operating as a stand-alone network or in cooperation with each other.

The media box 108 may include one or more receivers and transmitters for receiving signals and/or transmitting signals. For example, the media box 108 may be a set top box, a personal video recorder (PVR) (e.g., a digital video recorder (DVR)), and/or other various components and technologies for transmitting, receiving, and/or controlling media content. It should also be appreciated that High-Definition (HD) capabilities may also be provided.

The output device 110 may be any device capable of transmitting data, receiving data, and/or presenting data. In one embodiment, the output device may include a display device 110a, such as a television, a monitor, an interactive television, a receiver, a tuner, a high definition (HD) television, a HD receiver, a video-on-demand (VOD) system. In another embodiment, the output device may be a communications device 110d, such as a personal digital assistant (PDA), a mobile phone, a smart phone, a network appliance, an Internet browser, a pager, a mobile device, or a handheld device. In yet another embodiment, the output device may be a computer, such as a desktop computer 110a, a laptop/notebook 110b, a workstation, a thin system, a fat system, a remote controller, or other device 110e, such as a multimedia device, an alert device, an audio device (e.g., MP3 player), a video game console, a video game controller, a digital photo frame, a global positioning system (GPS), personal video recorder (PVR) (e.g., a digital video recorder (DVR)), or other device capable of transmitting, receiving, and/or presenting signals. It should be appreciated that the media box 108 and the output device 110 may be a single device and/or two devices communicatively coupled to each other. Other various embodiments may also be provided. It should also be appreciated that as used herein, “media device” may interchangeably refer to the media box 108 and/or the output device 110.

The multimedia module 104 (e.g., a video-on-demand (VoD) server) may include one or more processors (not shown) for providing multimedia-related data and/or information. For example, the multimedia module 104 may include a SQL Server, UNIX based servers, Windows 2000 Server, Microsoft IIS server, Apache HTTP server, API server, Java sever, Java Servlet API server, ASP server, PHP server, HTTP server, Mac OS X server, Oracle server, IP server, and/or other independent server to monitor and/or analyze the tickets generated by the one or more inputs 110. Also, the multimedia module 104 may store and/or run a variety of software, for example, Microsoft/NET framework.

The multimedia library 102 may communicate with one or more processors of the multimedia module 102 and may be configured to store and/or index data and/or information. It should be appreciated that the multimedia library 102 may be one or more databases. In this example, the multimedia library 102 may store data and/or information such as television (TV) programs, movies, advertisements, music videos, music, and/or other multimedia content. In one embodiment, the multimedia content may be available on demand (e.g., video-on-demand). In another embodiment, the multimedia content may be available once received from one or more external sources (not shown). The multimedia module 104 may be in communication with the media box 108 and/or output device, such that in the event a request for multimedia content is transmitted from the media box 108 and/or the output device 110 over the network 106 and received at the multimedia module 104, the multimedia module 104 may distribute the requested multimedia content to the media box 108 and/or output device 110. The one or more processors at multimedia module 104 may identify the desired data and/or information to optimize distribution and efficient delivery of the multimedia content. In addition to providing multimedia content, the multimedia module 104 may also record, store, and/or index multimedia-related data and/or information with or without the multimedia library 102 and/or other external sources.

Although the multimedia module 104 is depicted as one module, it should be appreciated that the contents of the multimedia module 104 may be combined into fewer or greater numbers of modules, servers (or server-like devices) and may be connected to one or more data storage systems, in addition to the multimedia library 102. Furthermore, the multimedia module 104 may be local, remote, or a combination thereof to the media box 108 and/or output device. The multimedia module 104 may also store additional data and/or information relevant for personalized functionalities. For example, the multimedia module 104 may store data including customer preferences, multimedia ratings, multimedia reviews, rebroadcast rights and information, etc. This data may be used for customizing services provided by or to a network provider hosting the multimedia module 104. The multimedia module 104 may also customize or personalize subscriber services by recording, storing, and/or indexing additional data/information related to customer preferences and/or viewing habits.

The multimedia module 104 may include one or more processors and one or more data storage systems to provide a quality metric/reference (or telemetry). In particular, the multimedia module 104 may process multimedia and generate a quality metric for distribution (e.g., packetization) along with on-demand multimedia content. It should also be appreciated that a quality metric/reference for multimedia may also be provided outside of the multimedia module 104. For example, a quality analyzer (not shown) may be communicatively coupled to the multimedia module 104 (e.g., direct coupling or via network 106) to provide the quality metric/reference.

The quality metric/reference may be sampled and processed into a stream (e.g., a partial reference stream) that is encoded to provide a quality reference to one or more multimedia streams of on-demand multimedia content. It should be appreciated that multimedia content provided by the multimedia module 104 may be compressed in a variety of formats. For example, these may include MPEG1, MPEG2, MP3, MPEG4, SDI (Serial Digital Interface), etc. In each of these examples, the compressed signals may include a number of elementary streams. An elementary stream in a digital video program, for example, may include an audio stream, a video stream, a closed caption stream, an English translation stream, a Spanish translation stream, etc. Thus, the multimedia module 104 may generate and incorporate a quality metric/reference as an elementary stream using a common program clock reference (PCR), which synchronizes the quality metric with other multiple elementary streams of a requested multimedia content (e.g., a movie selected for viewing, music files selected for listening, etc.). In some embodiments, the quality reference/metric may be formatted into an elementary stream (e.g., MPEG elementary stream via MPEG packetization. Through additional processing (e.g., multiplexing), a quality reference may be effectively provided in the on-demand multimedia content.

It should be appreciated that each of the components of the system 100 may be configured to receive, transmit, and/or process signals/data. For example, each of servers, server-like systems, and/or modules of the system 100 may have one or more receivers, one or more transmitters, and/or one or more processors in order to communicate (e.g., receive, process, and/or transmit data/information) with the other components of system 100. Communications may be achieved via transmission of electric, electromagnetic, optical, or wireless signals and/or packets that carry digital data streams using a standard telecommunications protocol and/or a standard networking protocol. These may include, but not limited to, Session Initiation Protocol (SIP), Voice Over IP (VoIP) protocols, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols. Other protocols and/or systems that are suitable for transmitting and/or receiving data via packets/signals may also be provided. For example, cabled network or telecom connections such as an Ethernet RJ45/Category 5 Ethernet connection, a fiber connection, a traditional phone wireline connection, a cable connection or other wired network connection may also be used. Communication between the network providers and/or subscribers may also use standard wireless protocols including IEEE 802.11a, 802.11b, 802.11g, etc., or via protocols for a wired connection, such as an IEEE Ethernet 802.3

It should be appreciated that one or more data storage systems (e.g., databases) (not shown) may also be coupled to each of the devices or servers of the system 100. In one embodiment, the one or more data storage systems may store relevant information for each of the servers and system components. Exemplary database information may include order request, order number, order sequence, network provider information, multimedia name/code, multimedia channel numbers, multimedia channel names, multimedia listings/categories, program schedules, multimedia availability, future and past programming information, ratings, viewer preferences, advertisement categories, advertisers, advertised products/services, and/or other information provided by a viewer, network provider, storage source (e.g., pre-recorded TV programs/movies), or other third party source.

It should be appreciated that the contents of any of these one or more data storage systems may be combined into fewer or greater numbers of data storage systems and may be stored on one or more data storage systems and/or servers. Furthermore, the data storage systems may be local, remote, or a combination thereof. In other embodiments, information stored in the databases may be useful in providing additional customizations for enhanced multimedia or TV-viewing experience.

Additionally, one or more processors (not shown) may also be coupled to each of the servers, modules, devices, system components, and/or the one or more data storage systems. It should be appreciated that the one or more processors may be used for at least processing, calculating, organizing, multiplexing, demultiplexing, remultiplexing, compressing, decompressing, formatting, and reformatting data and/or information. In another embodiment, for example, the one or more processors may be used for all logic processing, as described above, for efficient product delivery, network resource management, etc.

By performing the various features and functions as discussed above, quality-reference multimedia content may be efficiently provided and distributed for on-demand viewing, listening, and/or experiencing at one or more output devices 110. Providing a way for delivering quality-referenced multimedia may ultimately enhance the overall multimedia experience (e.g., TV-watching, music-listening, etc.). Accordingly, exemplary embodiments may expand the limited number of techniques for providing quality-referenced multimedia.

Providing quality-referenced multimedia may have several advantages. For example, as discussed above, degradation of multimedia content may be determined. This may be particularly helpful for improving multimedia quality at a remote site (e.g., media box 108 and/or output device 110). For example, degradation at the remote site may also be determined and compared to the quality metric/reference generated at the multimedia module 104. Quantifying the degradation at the remote site may indicate, for example, show that the multimedia content is fuzzy. Fuzziness, in this example, may be directly related to compression error. Accordingly, instructions may be provided to the multimedia module 104 and/or other vendor side network components/systems/servers (e.g., multiplexer) to increase bandwidth so that the on-demand multimedia may be kept from degrading beyond acceptable limits at the remote site. It should be appreciated that other degradation descriptions (e.g., blotchy, freezing, jerky, jittery, noise, etc.) may also indicate other sources for decreased multimedia quality and/or additional quality solutions.

It should be appreciated that that use of a quality reference delivered with multimedia content may be dynamic, automatic, and/or manual. For example, the quality reference may be automatically used to fine tune the vendor side components, systems, modules, and/or devices for improved multimedia quality. In another example, the quality reference may be useful for employing one or more redundant systems in the event various vendor side components, systems, devices, and/or modules are not operating properly. It should also be appreciated that a quality reference may also be used for logging details of system/network performance, where fine tuning is achieved manually over any desired period of time.

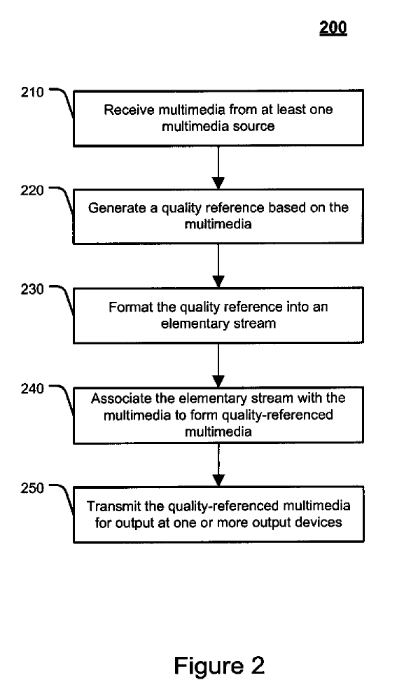

FIG. 2 depicts a flowchart of a method for providing quality-referenced multimedia 200, according to an exemplary embodiment. The exemplary method 200 is provided by way of example, as there are a variety of ways to carry out methods disclosed herein. The method 200 shown in FIG. 2 may be executed or otherwise performed by one or a combination of various systems. The method 200 is described below as carried out by the system 100 shown in FIG. 1 by way of example, and various elements of the system 100 are referenced in explaining the example method of FIG. 2. Each block shown in FIG. 2 represents one or more processes, methods, or subroutines carried in the exemplary method 200. A computer readable media comprising code to perform the acts of the method 200 may also be provided. Referring to FIG. 2, the exemplary method 200 may begin at block 210.

At block 210, multimedia may be received. For example, a receiver at the multimedia module 104 may be configured to receive multimedia from at least one multimedia source, e.g., the multimedia library 102. In some embodiments, the multimedia may be received via at least one of satellite, off air reception, optical fiber, and data storage. In some embodiments, the multimedia may be on-demand multimedia. In some embodiments, the multimedia may include at least one of a television program, a movie, a music video, an advertisement, a music file, an image, an electronic file, an electronic game, a website, an electronic message, a hyperlink, and an email.

At block 220, a quality reference may be generated. For example, one or more processors at the multimedia module 104 may be configured to generate a quality reference based on the multimedia received from the at least one multimedia source. In one embodiment, generating the quality reference may include rendering the multimedia in at least one of a National Transmission Standards Committee (NTSC) format, Programming Assembly Language (PAL) format, an MPEG (Moving Pictures Experts Group) format, a Serial Digital Interface (SDI) format, a High Definition Multimedia Interface (HDMI) format, SECAM (Sequentiel Couleur Avec Memoire or Sequential Color With Memory) format, and a component format. In some embodiments, generating the quality reference may comprise sampling multimedia parameters. In another embodiment, the quality reference may be a partial reference quality stream.

At block 230, the quality reference may be formatted into an elementary stream. For example, one or more processors at the multimedia module 104 may be configured to format the quality reference into an elementary stream. In some embodiments, the elementary stream may be formatted as an MPEG elementary stream. In other embodiments, the elementary stream may be formatted for MPEG packetization.

At block 240, the elementary stream may be associated with the multimedia. For example, one or more processors at the multimedia module 104 may be configured to associate the elementary stream with the multimedia to form quality-reference multimedia. In some embodiments, associating the elementary stream may comprise incorporating a common program clock reference (PCR) to synchronize the elementary stream with other streams of the multimedia. It should be appreciated that in some embodiments, formatting the quality reference into an elementary stream, as depicted in block 230, and associating the elementary stream with the multimedia, as depicted in block 240, may be achieved in one act or step.

At block 250, the quality-referenced multimedia may be transmitted. For example, a transmitter at the multimedia module 104 may be configured to transmit the requested multimedia content with the associated quality stream to display the requested multimedia content. In some embodiments, the quality-referenced multimedia may be stored at one or more data storage systems, such as the multimedia library 102 or other data storage system.

It should be appreciated that where latency may be accrued in the partial reference quality stream due to additional processing, identical (or near identical) latency may be applied to prior original signal processing (e.g., multiplexing), or removed and/or accounted for via buffering during system tests. It should be appreciated that while either way of applying latency is entirely acceptable (and only possible due to the fact that any such latency will be essentially static, e.g., if the embedded reference signal applies to a video frame or scene that preceded it by a finite amount of time), every portion of the video and partial reference signal may be displaced by the same amount of time.

It should also be appreciated that the partial reference quality stream may require no proprietary distribution system. For example, since the quality stream is generated as an elementary stream, the steam is in a digital format that is compatible with existing multimedia transport/delivery systems (e.g., using MPEG, SDI, etc.). As a result, such a quality stream may pass unhindered by any additional re-multiplexing, transcoding, distribution or processing, that may be applied to the original signal and may be delivered on-demand without a need to change transmission structures of current delivery protocols.

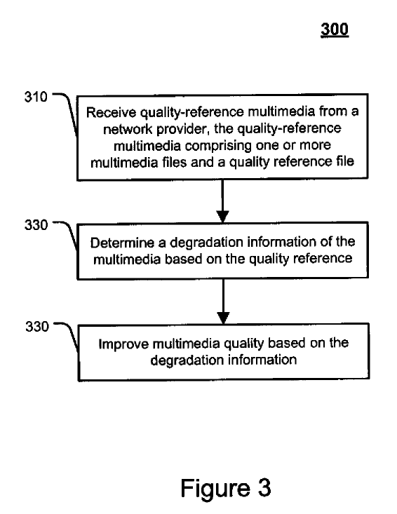

FIG. 3 depicts a flowchart of a method for providing quality-referenced multimedia, according to another exemplary embodiment. The exemplary method 300 is provided by way of example, as there are a variety of ways to carry out methods disclosed herein. The method 300 shown in FIG. 3 may be executed or otherwise performed by one or a combination of various systems. The method 300 is described below as carried out by the system 100 shown in FIG. 1 by way of example, and various elements of the system 100 are referenced in explaining the example method of FIG. 3. Each block shown in FIG. 3 represents one or more processes, methods, or subroutines carried in the exemplary method 300. A computer readable media comprising code to perform the acts of the method 300 may also be provided. Referring to FIG. 3, the exemplary method 300 may begin at block 310.

At block 310, quality-referenced multimedia may be received. For example, a receiver at the media box 108 and/or output device may receive quality-referenced multimedia from a network provider (e.g., multimedia module 104). In some embodiments, the quality-referenced multimedia may include one or more multimedia files and a quality reference file. In other embodiments, the multimedia may be on-demand multimedia. In some embodiments, the multimedia may include at least one of a television program, a movie, a music video, an advertisement, a music file, an image, an electronic file, an electronic game, a website, an electronic message, a hyperlink, and an email.

At block 320, degradation information may be determined. For example, one or more processors at the multimedia module 104, media box 108, and/or output device 110 may determine the degradation information associated with the multimedia by determining one or more delta values. As discussed above, in video content, for example, a quality metric/reference may indicate characteristics of the video content, such as brightness, color, contrast, etc. Thus, a description of multimedia content, frame-by-frame or other similar interval, may allow determination of the degradation information (e.g., in the form of one or more delta values) associated with the multimedia content.

At block 330, multimedia quality may be improved. For example, the system 100 (e.g., vendor side systems, components, devices, servers, and/or modules) may improve multimedia quality based on at least the degradation information determination (e.g., one or more delta values, etc.). In some embodiments, improving multimedia quality may include at least one of fine-tuning for optimum bandwidth, recording trends, and switching to one or more redundant systems. In other embodiments, improving multimedia quality may be performed automatically, semi-automatically, or manually.

Embodiments of providing multimedia quality may expand the limited number of techniques for ensuring a quality reference is provided for requested multimedia content. By capturing generating and providing a quality stream with one or more elementary streams of requested multimedia content, a customer/subscriber may experience quality-referenced multimedia content from the convenience of his or her multimedia device. As a result, the overall television-watching experience may be further enhanced because viewers may receive quality-reference multimedia content on-demand and spend more time enjoying such content at their convenience.

In addition to the benefits described above, embodiments of the system and method for providing multimedia quality not only provide an effective and improved technique for delivering quality-referenced multimedia, but also may allow multimedia providers (e.g., TV network providers) the ability to service a larger subscriber pool since existing protocols may remain intact. Moreover, advantages in business and marketing may also be apparent. When customers/subscribers become increasingly satisfied with a network provider, for example, customer loyalty and customer referrals may expand clientele. Additionally, providing such a technique for providing quality-reference multimedia may maximize advertisement and marketing opportunities with third party vendors, etc., which may not otherwise be provided.

While the features and functionalities of exemplary embodiments are primarily discussed with respect to providing quality-reference multimedia content, such as TV programs, it should be appreciated that the features and functionalities of one embodiment may be similarly applied to other embodiments. Furthermore, while the multimedia content is described primarily in reference to on-demand TV programs/shows, it should be appreciated that the functions and features of the embodiments of the system and method may apply similarly to a host of other multimedia and non-multimedia content as well, where applicable.

While the embodiments described above may be directed to the multimedia module 104 and the media box 108 to provide quality-referenced multimedia as discussed above, it should be appreciated that other components, such as an output display device 110, a recording system, other vendor-side/subscriber-side components, etc., may include processing capabilities to perform the features described above as well. Additionally, it should be appreciated that one or more of these devices and/or components may be combined (e.g., a TV and a network card) to provide the quality referencing features described above.

Furthermore, although the embodiments described above are directed toward television multimedia content, it may be readily appreciated that the features and may apply to any video, audio, and/or web-based component, such as computers, communications devices, PVRs or DVRs, multimedia websites/servers, DVDs players, VCRs, CD players, MP3s players, etc.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A computer-implemented method, comprising:
receiving, at a multimedia module, multimedia from at least one multimedia source;
generating, at the multimedia module, a quality reference based on the multimedia;
formatting, at the multimedia module, the quality reference into an elementary stream;
associating, at the multimedia module, the elementary stream with the multimedia to form quality-referenced multimedia; and
transmitting, from the multimedia module, the quality-referenced multimedia to one or more output devices.

2. The computer-implemented method of claim 1, wherein the multimedia is received via at least one of satellite, off air reception, optical fiber, and data storage.

3. The computer-implemented method of claim 1, wherein the multimedia comprises on-demand multimedia.

4. The computer-implemented method of claim 1, wherein the multimedia comprises at least one of a television program, a movie, a music video, an advertisement, a music file, an image, an electronic game, a website, and an electronic message.

5. The computer-implemented method of claim 1, wherein generating the quality reference comprises rendering the multimedia in at least one of a National Transmission Standards Committee (NTSC) format, Programming Assembly Language (PAL) format, an MPEG (Moving Pictures Experts Group) format, a Serial Digital Interface (SDI) format, a High Definition Multimedia Interface (HDMI) format, SECAM (Sequentiel Couleur Avec Memoire or Sequential Color With Memory) format, and a component format.

6. The computer-implemented method of claim 1, wherein generating the quality reference comprises sampling multimedia parameters.

7. The computer-implemented method of claim 1, wherein the quality reference is a partial reference quality stream.

8. The computer-implemented method of claim 1, wherein the elementary stream is formatted as an MPEG elementary stream for MPEG packetization.

9. The computer-implemented method of claim 1, wherein associating the elementary stream comprises incorporating a common program clock reference (PCR) to synchronize the elementary stream with other streams of the multimedia.

10. The computer-implemented method of claim 1, further comprising storing the quality-referenced multimedia at one or more data storage systems.

11. A computer readable media comprising code to perform the acts of the computer-implemented method of claim 1.

12. A computer-based system, comprising:
a receiver configured to receive multimedia from at least one multimedia source;
one or more processors configured to generate a quality reference based on the multimedia, format the quality reference into an elementary stream, and associate the elementary stream with the multimedia to form quality-referenced multimedia; and
a transmitter configured to transmit the quality-referenced multimedia to output at one or more output devices.

13. The computer-based system of claim 12, further comprising one or more storage systems for storing the quality-referenced multimedia.

14. A computer-implemented method, comprising:
receiving, at a media device, quality-referenced multimedia from a network provider, wherein the quality-referenced multimedia comprises one or more multimedia files and a quality reference file;
determining, at the media device, degradation information of the multimedia based on at least information in the quality reference file; and
improving multimedia quality based at least in part on the degradation information determined at the media device.

15. The computer-implemented method of claim 14, wherein the multimedia comprises on-demand multimedia.

16. The computer-implemented method of claim 14, wherein the multimedia comprises at least one of a television program, a movie, a music video, an advertisement, a music file, an image, an electronic file, an electronic game, a website, and an electronic message.

17. The computer-implemented method of claim 14, wherein improving multimedia quality comprises at least one of fine-tuning for optimum bandwidth, recording trends, and switching to one or more redundant systems.

18. The computer-implemented method of claim 14, wherein improving multimedia quality is performed automatically or semi-automatically.

19. A computer readable media comprising code to perform the acts of the computer-implemented method of claim 14.

20. A computer-based system, comprising:
a receiver configured to receive quality-referenced multimedia from a network provider, wherein the quality-referenced multimedia comprises one or more multimedia files and a quality reference file;
one or more processors configured to determine degradation information of the multimedia based on at least information in the quality reference file and improve multimedia quality based at least in part on the degradation information.
